(19) United States
(12) Patent Application Publication
(10) Pub. No.: US 2020/0261808 A1
(43) Pub. Date: Aug. 20, 2020

(54) COMPUTERIZED SYSTEM, METHOD AND COMPUTERIZED PROGRAM PRODUCT FACILITATING GAMES IN CONJUNCTION WITH A MESSAGING SERVER

(71) Applicant: Malam Joy Ltd., Petach Tikva (IL)

(72) Inventor: Yaakov JOSHUA, Ganei Tikva (IL)

(21) Appl. No.: 16/788,674

(22) Filed: Feb. 12, 2020

Related U.S. Application Data
(60) Provisional application No. 62/806,834, filed on Feb. 17, 2019.

(51) Int. Cl. A63F 13/87; A63F 13/35

(52) U.S. Cl. CPC A63F 13/87; A63F 13/35

(57) ABSTRACT

A computerized system operative in conjunction with chat functionality which generates chats between chat participants aka chatroom members, wherein each chatroom member generates at least one chat communication within the chat, each chat participant being a cellphone user, each chat participant's cellphone having a display screen, the system including: a game server including a hardware processor and operating at least one computerized game which, when started or joined by a chat participant, allows the chat participant to generate at least one game action within the game; and a client hardware processor e.g. cell app e.g. instant messaging app, that presents, on chat participants' cellphones' display screens, a single chronologically ordered feed of communications including both chat communications and game actions.

### REFERENCE TO CO-PENDING APPLICATIONS

Priority is claimed from U.S. Provisional Patent Application No. 62/806,834 “Social collaboration platform having gaming functionality which interfaces with chat functionality”, filed 17 Feb. 2019, the disclosure of which application/s is hereby incorporated by reference.

### FIELD OF THIS DISCLOSURE

The present invention relates generally to games and more particularly to games played via an end-user's cellphone.

### BACKGROUND FOR THIS DISCLOSURE

Chat apps like Facebook Messenger, Whats app, Wechat are known.

Games app such as Chess.Com, Clash Royal, Fortnight are known.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

Certain embodiments seek to provide a social collaboration platform having gaming functionality and game selection functionality, which interfaces with chat functionality in which game communications are interspersed with regular chat, thereby yielding a single chat feed in which communications, whether pertaining to the game or to regular chat, are presented generally chronologically.

Chat apps like Facebook Messenger, Whats app, Wechat etc. are the way small groups communicate together in the virtual world. Whenever group members want to play, they need to step out from the app chat feed and go to a different user experience solution. Game apps such as Chess.Com, Clash Royal, Fortnight etc. contain embedded “in game” chat features. If members of the game want to play a different game, they need to move from the game to a different app.

The cell application described herein typically solves this problem by adding a playing mode game in a chat app. Various embodiments are now described, by way of example. All or any subset of the illustrated and/or described characteristics of each embodiment may be provided.

The game may be played by natural language inside the chat, using exactly the same interface that is used for chatting.

The games may be games that need no board and may be played just by typing; most of these games are played by speaking in the real world.

The app described herein may provide a collection of games that can be played just by using regular chat functionality such as writing text, loading media files etc.

The cell application described herein typically may handle the game in all of its phases; from the start, during the game, and finally at the end, deciding who wins, and who loses. Each game session may provide score results for each user that may be added to the player. The result of this may be a social rating for each player, encouraging the user to continue social interaction.

Some games may be customized by users, creating the ability for groups to create their own private games.

Facebook Messenger allows users to launch games from a chat, but once they are in the game, they are not in a chat. Many games like Chess.com, Fortnight, allow chat during the game, but one is not able to move to a different game. Some platforms such as Kahoot.com allow users to customize games, but they are not chats.

Only the cell application described herein typically may provide a game extension inside the chat, staying in the chat, and playing the game by chatting.

The solution is a platform that is fused with interactive group games. The games may utilize the social platform for collaboration, positive interaction between players, joint strategy decisions, and complimenting rival players. The social interaction may be part of the actual engagement, and may add social interaction to the game itself.

In software, Gamification is defined as the application of game-design elements and game principles in non-game contexts. The cell application described herein typically may provide Gamification design for chats, different from all existing chat apps.

Terms used herein may be construed either in accordance with any definition thereof appearing in the prior art literature or in accordance with the specification, or to include in their respective scopes, the following:
Chat area—an area where users “chat”. Users (players) can write and read messages as in a regular chat, but can also perform actions in the game by texting.
Game area—an area in the app may show characteristics of the game so that players can understand the current state of both individual and shared data.
GameInstance—an instance of a single game during a chat in a given group.
PlayByChat—a user interface principle of the app—any input of the game, which may be by regular chat submission.
GameRuleEngine—a part of the software in charge of analyzing the chat submit and deciding how it affects the GameInstance.
User\Players—the app is for chatting and for playing. When using the expression User, this refers to chat functionality. When using the expression Player, this refers to a user using a game functionality.

app page list

| Page | Purpose | Remark |
|---|---|---|
| Login | For first time | OTP login by Phone |
| | | Set language by OS |
| Groups | Users Groups To Navigate | |
| | Between Chats | |
| Create Group | Create And Edit Groups - | Get Users From Device |
| | mainly Add Users To group | Contact list |
| Main page | Chat and Game interface | Where a chat and game |
| | creating a GameInstance | experience are combined |
| User Settings | Edit User and show | |
| | usersGame statistics | |
| Group Settings | Edit Group and show group | |
| | Game statistics | |

Alternatively, the App page list of FIGS. 1a-1b may be employed.

A suitable page layout may be in accordance with FIG. 2a. The main page typically enables three different layouts, to provide a user experience of what players want to focus on.
Vertical for focusing on Game Area
Full Chat for focusing on chat area as in regular chat
Horizontal for equal focus between areas

In each layout, users may be able to change the size by sliding the fingers.

App Functionality

| | | IS | Pages | Implementation |
|---|---|---|---|---|
| # | Functionality | Unique | Involved | remark |
| 1 | First Login | No | Login | OTP Service |
| 2 | Creating a Group, | No | Groups, | XMPP server |
| | Viewing My Groups | | Create Group | |
| 3 | Chatting by text voice | No | Main page | XMPP server |
| | an media files | | | |
| 4 | Starting a game during | Yes | Main page | |
| | chat | | | |
| 5 | Game management | Yes | Main page | |
| 6 | Offline mode | No | | Push notification |
| 7 | User social rating | Yes | User Settings | |
| 8 | Game Content | Yes | Backend | |
| | management | | Website - not | |
| | | | on app | |
| 9 | Rewards for real world | yes | | GPS |
| | interaction | | | |

Each functionality describing the SW design, with details for unique parts, is now described.

### First Login

Users load the app and are required to write their name, and add a picture (optional), and phone number.

App calls Login-API which generates a random OTP text, and sends it by SMS to the user.

Users write the code of the SMS, are then registered as users in the XMPP server, and may load the group page.

### Creating a Group, Viewing My Groups

App may call the XMPP server API, to show in which groups users are listed. Users may be able to create a new group and define users from their contact list.

Each user added after this to a group, may be notified. If the added user has already installed the app, this is done by Push notification, and, if not, this is done by an SMS that has a link to download the app.
All this functionality may be done by an open source XMPP server such as Openfire, Prosody, and Jabber.

### Chatting by Text Voice and Media Files

A user may be able to chat by sending text media to all other users in the group. This feature may also be done by calling the XMPP server, which may send the user's input to all group members. If a group member's app is not active, he may get a push notification using firebase FCM.

### Starting a Game During Chat

While chatting, if no Gameinstance exists, the game area may show a game catalog. The game catalog is a list of games that Game-Api returns. Once any users in the chat select a game from the game catalog, the following logic begins:

All users get text in the chat area—“user X started a game Y. Write # in to participate” The GameInstance-Api is called and a new GameInstance is created and attached to the group.

Whenever any user types “# in” in the chat text box, this means he wishes to participate.

The app may add the user that typed “# in” as a participant in the Game Area. In addition, it may add the entry text he wrote as regular chat text.

The question is, how does the app recognize the difference between ordinary chat text, and text that effects the games? The following sequence may provide this mechanism, described as a PlayByChat pattern.
1. User submits text
2. Text is sent to the XMPP server and to all group users
3. Text is also sent from the XMPP server to the GameInstance-Api, which, by using GameRuleEngine, may compute how the text affects the Game instance.
   a. If the text affects the server, may call the XMPP server to send text to all users' chat area and game area
   b. As in all push notification services, when the app is not active, it may alert users through the OS, that something has happened in the game.
Any suitable PlayByChat flow may be employed, e.g. as shown in the quiz game table herein.
   PlayByChat pattern is the core of the app. Every different game may implement a different computing, but all affect the interface of the chat in the same way, merely by sending another message to the chat updating the players on what has changed in the game. PlaybyChat symbolizes what happens in our mind within real situation speech games—every player computes the words a players has said, and acts accordingly.

Assume a step-by-step start session of a game, where there are three users in the group (Bob, Alice, Eve), wherein Bob requested to start a game called “Guess my fruit”:

Alice Bob and Eve Game start chat flow

| Who | Typed text | Game area | Chat area |
|---|---|---|---|
| | | Bob started | System: Bob started “guess my fruit”. |
| | | game | Write #in to participate |
| | | Waiting for | |
| | | participants | |
| Alice | Hi how are | Bob Started | System: Bob started “guess my fruit”. |
| | you my | Game | Write #in to participate |
| | friends | Waiting for | Alice: Hi, how are you my friends |
| | today? | participants | today? |
| Eve | Fine! #in | Bob Started | System: Bob started “guess my fruit”. |
| | | Game | Write #in to participate |
| | | Eve Is in | Alice: Hi, how are you my friends |
| | | | today? |
| | | | Eve: Fine! #in |
| | | | System: Eve entered game |
| Eve | Alice, | Bob Started | System: Bob started “guess my fruit” |
| | come | Game | Alice: Hi, how are you my friends |
| | join us | Eve Is in | today? |
| | | | Eve: Fine! #in |
| | | | System: Eve entered game |
| | | | Eve: Alice come join us |
| Alice | #in let's | Bob Started | System: Bob started “guess my fruit” |
| | play [symbol] | Game | Alice: Hi how are you my friends |
| | | Eve is in | today? |
| | | Alice is in | Eve: Fine! #in |
| | | Waiting to | System: Eve entered game |
| | | start | Eve: Alice come join us |
| | | | Alice: #in let's play [symbol] |
| | | | System: Alice entered game |
| Bob | Let the | Game started | System: Bob started “guess my fruit” |
| | game | | Alice: Hi, how are you my friends |
| | #start | | today? |
| | | | Eve: Fine! #in |
| | | | System: Eve entered game |
| | | | Eve: Alice come join us |
| | | | Alice: #in let’s play [symbol] |
| | | | System: Alice entered game |
| | | | Bob: Let the game #start |
| | | | System: game Started |

The example above demonstrates the idea how natural text writing in a chat affects the game. The “# in” “# start” key words let the game go on, while users can have a regular chat that does not affect the game. This behavior creates unique interaction in the chat, providing a positive social get-together experience, which is not possible with any other app.

This interaction may increase during the game itself, as described forthwith. Three are many properties to start a game that the start game may provide, such as all or any subset of:

maxPlayer—the number of maximum players the game requires
minPlayer—the number of minimum players the game requires
AutoInitTime—the minutes until the game may start automatically when all requirements may be fulfilled.
Autotimeout—the minutes the until game may expire when not activated.
AssetCollection—words users should provide in the “Starting a game during chat” Step

### Game Management

Game management is the period where a game instance is played in the chat after the starting phase.

Chat may support many kind of games—every submitted text may go through the PlayByChat flow while the difference may be the effect of the GameRuleEngine.

The cell application described herein typically may have several game categories, each one with a collection of games.

TargetTextGames—a game where the main purpose is that the players need to find a text.

RoleGames—game where players vote for each other, and the winner has the most votes.

MotionGames—games where motion gestures of the phone provide a winner

All games may have AppOnStart, AppOnGame, and AppOnEnd Events.

Below are some games that may be implemented by the cell application described herein typically. In each example, documents describe a unique platform benefit.

### Game 1—“Guess Who”

Game Rule—Each player is assigned a celebrity/fruit/city. All players know what the other players have been assigned, but not their own. By asking each other questions, players get clues about their word. The first player to guess his word is the winner. The player that tries to guess more than 5 times, is out of the game.

AppOnStart—GameRuleEngine randomly assigns each player a target word from the word collection of the game.

In the Game Area, each player may view all other users' target words, but not his own. AppOnGame—with PlayByChatFlow GameRuleEngine may check if any of the words users submitted start with # prefix. If he does check, it may try to match between the word and the target word of the user. If it matches, he is the winner, and Game instance moves to OnEnd Period.

If there is an 80% match between the words, the chat area says the user is close, and he should try again.

If there is less than a 80% match, the number of guesses per player continues. After five guesses, the player is out of the game. The Above AppOnStart—may be called “Target Match Basic Rule”.

AppOnEnd—Players get ratings by the results and the game area shows the winner, and allows to start a different game, or plays the same game again.

Following is a fast chat from Alice's perspective, playing “Guess Who” with Bob and Eve, after starting the game.

TABLE
Alice Bob And Eve Playing “Guess who?”

| # | Who | Typed text | Game area | Chat area |
|---|---|---|---|---|
| 1 | | | BOB - Bill | |
| | | | Clinton | |
| | | | Eve -Michal | |
| | | | Jordan | |
| | | | Alice - ? | |
| 2 | Alice | Hi how are | BOB - Bill | Alice: Hi, how are you my |
| | | you my | Clinton | friends today? |
| | | friends | Eve -Michael | |
| | | today? | Jordan | |
| | | | Alice - ? | |
| 3 | Eve | Fine, is mine | BOB - Bill | Alice: Hi, how are you my |
| | | a male? | Clinton | friends today? |
| | | | Eve -Michael | Eve: Fine, is mine a male? |
| | | | Jordan | |
| | | | Alice - ? | |
| 4 | Bob | Yes Eve | BOB - Bill | Alice: Hi how are you my |
| | | | Clinton | friends today? |
| | | | Eve -Michael | Eve: Fine is mine a male? |
| | | | Jordan | Bob: Yes, Eve |
| | | | Alice - ? | |
| 5 | Alice | I need coffee | BOB - Bill | Alice: Hi, how are you my |
| | | to wake up | Clinton | friends today? |
| | | | Eve - Michael | Eve: Fine is mine a male? |
| | | | Jordan | Bob: Yes, Eve |
| | | | Alice - ? | Alice: I need coffee to wake up |
| 6 | Eve | Maybe its | BOB - Bill | Alice: Hi,, how are you my |
| | | #Donald | Clinton | friends today? |
| | | Trump | Eve (1 guess) - | Eve: Fine is mine a male? |
| | | | Michael Jordan | Bob: Yes, Eve |
| | | | Alice - ? | Alice: I need coffee to wake up |
| | | | | Eve: Maybe its #Donald Trump |
| | | | | System: Eve 1 guess wrong |
| 7 | Eve | I know its | BOB - Bill | Alice: Hi how are you my |
| | | # Michael | Clinton | friends today? |
| | | Jordan, I | Eve (1 guess) - | Eve: Fine is mine a male? |
| | | love him | Michael Jordan | Bob: Yes Eve |
| | | | Alice - ? | Alice: I need coffee to wake up |
| | | | | Eve: Maybe its #Donald Trump |
| | | | | System: Eve 1 guess wrong |
| | | | | Eve: I know its # Michael |
| | | | | Jordan, I love him |
| | | | | System: Eve, you are Close |
| 8 | Eve | # Michael | Eve Wins | Alice: Hi, how are you my |
| | | Jordan? | Play again or | friends today? |
| | | | choose a | Eve: Fine, is mine a male? |
| | | | different game | Bob: Yes, Eve |
| | | | | Alice: I need coffee to wake up |
| | | | | Eve: Maybe its #Donald Trump |
| | | | | System: Eve 1 guess wrong |
| | | | | Eve: I know its # Michael |
| | | | | Jordan, I love him |
| | | | | System: Eve, you are close, |
| | | | | try again |
| | | | | Eve# Michael Jordan? |
| | | | | System: Eve wins |

In steps 2 and 5 Alice is chatting and not affecting the game at all.

In step 3 and 4 Eve and Bob are playing the game, but game area is not affected by it.

In step 6, 7, 8 Eve's text affects the game and changes both chat and game area.

These three examples may appear in many games, and shows how the cell application described herein typically may create positive interaction between players, joint strategy decisions, and complimenting rival players.

Game 2—“The fastest typist”

Game Rule—“A text is written and the first player to type the exact text is the winner.

AppOnStart—GameRuleEngine randomly picks a text from the word collection of the game.

In the Game Area all players see the same text.

AppOnGame—Target Match Basic Rule (as in “Guess who?”)

AppOnEnd—As in “Guess who?”.

Here is a fast chat from Alice's perspective, playing “The fastest typist” with Bob and Eve:

TABLE
Alice Bob And Eve playing “The fastest typist”

| # | Who | Typed text | Game area | Chat area |
|---|---|---|---|---|
| 1 | | | Type | |
| | | | @#$%W\hat{ }&*() | |
| 2 | Alice | Hi, how are you | Type | Alice: Hi, how are you |
| | | my friends today? | @#$%W\hat{ }&*() | my friends today? |
| 3 | Eve | #@#$%WA\hat{ }&*() | Type | Alice: Hi, how are you |
| | | | @#$%W\hat{ }&*() | my friends today? |
| | | | | Eve: #@#$%WA\hat{ }&*() |
| | | | | System: Eve, You are |
| | | | | close |
| 4 | Bob | I will win | Bob Wins | Alice: Hi, how are you |
| | | #@#$%W\hat{ }&*() | Play Again Or | my friends today? |
| | | | Choose a | Eve: #@#$%WA\hat{ }&*() |
| | | | different game | System: Eve, You are |
| | | | | close |
| | | | | Bob: I will win |
| | | | | #@#$%W\hat{ }&*() |

This chat example demonstrates more unique capabilities of the app.

If we compare “The Fastest Typist” and “Guess Who?” games, the only difference is the appearance of the target word that the players should guess. In “Guess Who” other player's target words can be seen, and in “The Fastest Typist” the target word is shared.

By a small change in the appearance rule, a completely new game is created.

Unlike Facebook messenger games (https://www.youtube.com/watch?v=DSdXz2uWX8)—switching games keeps the players in the chat app exactly in the same interface where the game was launched. Scrolling the chat area up may show what happened, regardless of which games were played. There is no other existing chat app that mimics this behavior. Unlike many popular games, such as Chess.com, Fortnight, Clash of Clans, etc. which have chat capabilities aside from the game, they must remain in the game.

Remaining exactly with the same chat interface for all games may create a “know one, know all” experience. This can be achieved because, typically, the core of the game is just chatting, and chatting is typically always the same.

### Game 3—“Quiz”

Game Rule—A Hint (Question) appears on the screen. The target word (answer) is hidden from players. The first player to write the correct target word (answer) is the winner.

AppOnStart—GameRuleEngine randomly picks a pair of hint and target words from the words collection. In the Game Area, all players see the same hint.

AppOnGame—Target Match Basic Rule

AppOnEnd—as in all games

Here is a fast chat from Alice's perspective, playing a Quiz with Bob and Eve, while the target word is tongue

TABLE
Alice Bob And Eve Playing Quiz

| # | Who | Typed text | Game area | Chat area |
|---|---|---|---|---|
| 1 | | | What tastes | |
| | | | better than it | |
| | | | smells? | |
| 2 | Alice | Wow that's | What tastes | Alice: Wow that's, hard, I do not |
| | | hard, I do not | better than it | have a clue |
| | | have a clue | smells? | |
| 3 | Eve | How can you | What tastes | Alice: Wow that's hard, I do not |
| | | compare | better than it | have a clue |
| | | taste than | smells? | Eve: How can you compare taste |
| | | smell | | to smell? |
| 4 | Bob | Maye be its | What tastes | Alice: Wow, that's hard, I do not |
| | | an #onion | better than it | have a clue |
| | | | smells? | Eve: How can you compare taste |
| | | | Bob 1 guess | to smell? |
| | | | | Bob: Maybe it's an #onion |
| | | | | System: Bob is wrong |
| 5 | Bob | Wait, my son | What tastes | Alice: Wow that's hard, I do not |
| | | is here, he | better than it | have a clue |
| | | likes riddles | smells? | Eve: How can you compare taste |
| | | | Bob 1 guess | to smell |
| | | | | Bob: Maybe it's an #onion |
| | | | | System: Bob is wrong |
| | | | | Bob: Wait, my son is here, he |
| | | | | likes riddles |
| 6 | Bob | Again I win | Bob wins | Alice: Wow that's hard, I do not |
| | | my friends, | Play Again or | have a clue |
| | | nice one, | choose a | Eve: How can you compare taste |
| | | its #tongue | different game | to smell? |
| | | | | Bob: Maybe it's an #onion |
| | | | | System: Bob is wrong |
| | | | | Bob: Again I win my friends, |
| | | | | nice one, it's #tongue |
| | | | | System: Bob wins |
| 7 | Alice | It's not fair, | Bob Wins | Alice: Wow, that's hard, I do not |
| | | you had help | Play Again or | have a clue |
| | | [symbol] | choose a | Eve: How can you compare taste |
| | | | different game | to smell? |
| | | | | Bob: Maybe it's an #onion |
| | | | | System: Bob is wrong |
| | | | | Bob: Again I win my friends, |
| | | | | nice one, its #tongue |
| | | | | System: Bob wins |
| | | | | Alice: It's not fair, you had |
| | | | | help [symbol] |

Quiz game example shows us two more features Target Games may contain.

First—the ability to edit and pre define the words collection to personalize a game. The app may provide a backend website where users may be able to customize the games by providing their own word collection. This feature is similar to other providers such as Google survey and Kahoot, but with one major difference. The Custom game may be played inside the chat; and/or

Second—the Hint part, which in Quiz was a riddle, is not just a sentence. It can be an image, a math exercise—as long as the hint hides a target word, the game may be the same—players talking. Once the chat text box includes the target word, there is a winner. This is a dynamic tool for constructing many different interactions.

In the Alice, Bob, and Eve playing quiz example, in step 7 it may be seen that the game is over, but still Alice refers to it. This is a major objective of the app—to create positive interaction between the chat members. If a family playing a board game around the table constitutes quality time, then chatting with the cell application described herein typically may be the maximum quality interaction in any app.

The previous three examples of games (Guess Who, Fastest Typist, Quiz) are all TargetTextGames.

The cell application described herein typically provides additional types of games. The next games described are role games.

In these types of games, each player has a role. The purpose of these games is for all players to match between roles and the players. This is done by voting, and the result of all votes affects the game. Every different role game may provide different rules.

Role games do not only involve the voting process, but rather the chat itself between the players. This chat affects the player's decision on his vote. This involves strategy alliances between participants, all done by regular chat, thus enriching the chat.

### Game 4—“Red vs Black”

Game Rule—All players get one of two different roles—red or black. The red players are the minority. The red players know about all other red players, but the black players just know about themselves. Each round, all players vote against one red player. After the majority of players have decided about the same player, he is out of the game. The game ends if all red players are out (black player wins), or when red players become the majority.

AppOnStart—GameRuleEngine randomly Assigned Red or Black to each player, making the red players the minority. The Play Area may show “You are Black” for Black Role Player, and for red players it may show all the red players.

AppOnGame—with PlayByChat Flow GameRuleEngine may check if any of the words users submitted start with # prefix. If they do, it may try to match between one player and the text written after it. If there is a match, the app may understand that this selection is a signal that the player has chosen that player as red. When all players choose a player and there is a majority for that choice, that user is out of the game, and a recheck needs to be done to see whether the game has ended.

To make it easier to choose a player while game is on, typing # in the chat box may open the list of available players in the game.

AppOnEnd—As in all games.

Following is an example of a Red vs Black game.

On Game start, Alice and Eve are red in their Game Area—It is indicated that they are both red (the minority). In Bob, Dan and Gil's Game Area, it is indicated that he is black, but without knowing who else is black.

TABLE
Alice Bob Eve Dan And Gil Playing Red Vs Black

| | | | Game area | |
|---|---|---|---|---|
| | | | (Alice point of | |
| # | Who | Typed text | view) | Chat area |
| 1 | | | You and Eve are | |
| | | | red. | |
| 2 | Alice | #Bob | Alice: Bob | Alice: #Bob |
| | | | Bob: | System: Alice picked Bob |
| | | | Eve: | |
| | | | Dan: | |
| | | | Gil | |
| 3 | Bob | Why are you picking | Alice: Bob | Bob: Why are you picking me again |
| | | me again and again | Bob: | and again? |
| | | | Eve: | |
| | | | Dan: | |
| | | | Gil | |
| 4 | Bob | You pick Me. I will | Alice: Bob | Bob: Why are you picking me again |
| | | pick you #Alice | Bob: Alice | and again? |
| | | | Eve: | System: Bob picked Alice |
| | | | Dan: | |
| | | | Gil: | |
| 5 | Eve | Bob, you are defensive | Alice: Bob | Eve: Bob, you are defensive |
| | | | Bob: Alice | |
| | | | Eve: | |
| | | | Dan: | |
| | | | Gil: | |
| 6 | Eve | #Bob | Alice: Bob | Eve: #Bob |
| | | | Bob: Alice | System: Eve picked Bob |
| | | | Eve: BoB | |
| | | | Dan: | |
| | | | Gil: | |
| 7 | Dan | #Eve called me and told | Alice: Bob | Dam #Eve called me and told me to |
| | | me to write Bob . . . so | Bob: Alice | write Bob . . . so I think it's Eve |
| | | I think it's Eve | Eve: BoB | System: Dan picked Eve |
| | | | Dan: Eve | |
| | | | Gil: | |

The following example is just a glimpse of the full chat for this game, which shows how the voting sequence works.

The communication between the players about the game can be outside of the app. The game gives the group chat a new perspective; it might take hours and thousands of chat text messages until there is a winner. It can be the only things users are referring to in the text, but it can also be just a side effect of the conversation. This is what the cell application described herein typically wants to achieve—to make the chat more fun.

The example sharpens the User Interface rules.

Game Area—may be the game's current state and could appear differently between players as the game.

Chat Area may be always the same and is a bulletin board of all messages+system messages when a text affects the game.

Game Action may be a text submitted in the chat.

There are many role games that may be in the game collection. They are played in party games when people meet. The cell application described herein typically may make them accessible in a chat.

### Game 5—“Killer”

Game Rule—In this game there are 3 roles—killer, policeman, and citizens.

The Killer's mission is to kill all citizens, while the citizen tries to find the killer.

Each round, the policeman points out one player and the system tells him his role.

Then, killers point out a player. If all killers pointed out the same player, he is out of the game.

Then all players vote about who is the killer. When all players have a majority decision, player role is known. During the voting time, players try to convince each other with information they know, to help them win.

Game ends either when only killers are left, or no more killers are left.

This game is a sub version of a mafia game. https://en.wikipedia.org/wiki/Mafia (party game)

AppOnStart—GameRuleEngine assigns roles randomly to the players

AppOnGame—while chatting, the 3 round steps are down

Killers point to other players. If all killers pick the same player, he is out.

Policeman get information about the role of one player.

All players vote about the killer player, as in red vs black voting.

AppOnEnd—Players get rating by the results and the game area shows the winner and allows starting a new different game, or plays the same game again.

Killer game shows how complex rules can be played inside a regular chat. If it can be played when people meet just by speaking, by definition it can be played in the App described herein.

Thousands of known and not yet invented games are available to be included in the cell application described herein typically.

Many of these games might have a specific web site/app to be played, such as https://play.google.com/store/apps/details?id=com.smartparrot.mafiapartygame.classic&h 1=en US

Yet, none of them are played inside a regular chat app. The cell application described herein typically aims to be the one-stop-shop for all games that can be played only with a natural language-chat.

The cell application described herein typically wants to take the experience of social gatherings and tries to transform this experience inside the app.

Social meetings are not just about talking, but also about human emotion. The App may take advantage of Phone Motion sensors to reduce the gap between real social meetings, and virtual meetings.

Motion games are small challenges all players get, and the first one to get to the end may be the winner.

All motion games have the same idea: the app writes a motion challenge that can be measured by the app. The first one to complete the challenge is the winner.

Examples of motion challenges
Move 100 meters (requires GSP enable)
Flip the phone from vertical to horizontal 10 times.
Load a picture of cat/blue car/smile etc.—app may check the image by a recognition API.
   While the challenge is being carried out by players, they can chat, as in the real world when people compete amongst themselves.

Offline Mode—

As in any chat app, every text that is written in the group may be saved in the smartphone local storage for offline viewing. When a new text is sent to a user and his app is not active, push notification may send it to the device, and it may appear on the phone.

User Social Rating—

all games may reward the player with points. This may create a social rating for a user. A user may have a rating for a partial game, and for entire games that he has played.

Game Content Management—

Users may be enabled to build games. As in the Quiz Game example, the user may be able to create his own collection of target words and hints. Games may have private and public modes. Private games may be played only by the users that the game creator has in his group. Public games may be enabled to all users. The platform may reward users when their public games are played many times.

Rewards for Real World Interaction—

The cell application described herein, typically values social interaction. Thus, it rates RealWorld interaction as being more valuable than virtual interaction. When the App detects, by GPS information, that all group users are together in the same area, it may upgrade that meeting by adding a social rating to group members.

Game Rule Engine may be invoked for any chat that is submitted during a game instance. The design of FIG. 6, which is a Game Rule Engine class diagram, is one possible implementation.
ChatMsg
   Basic data every submit passes
GameChangedEventsArgs
   Basic data passes to client when game changes
Game factory
   Initialize the correct IGameRuntime
   Listen's to IGameRuntime.GameChanged event with OnGameChanged delegate
   Calls IGameRuntime.HandleMsg method
   OnGameChanged calls Xmpp server to notify players on change
Poco objects
   Hold data about the game
   Each game may hold data it needs
BaseGame
   Shared logic between games as
      Starting a game
      In memory saving of Pocos
      Text parsing
IGameRuntime:Games (QuizGame,GuessWhoGame)
   Deciding how to change Poco due to submit and specific game rules.
   Convert Event and Poco to GameChangedEventsArgs
   Firing GameChanged with GameChangedEventsArgs
   Call LogApi when needed

The term “chat” may refer to any real-time communication (typically text-messages via keyboard or verbal, audio, visual or audio-visual (A/V) communication) between plural users on a local network or Internet. Characters may be transmitted after each key is pressed, or only when the user presses EnterSoftware may be provided that supports Internet Relay Chat (IRC) or an instant messenger application in which a single server manages chat communication between plural end users or clients. For example, Facebook Messenger is a messaging app and platform with standalone iOS and Android apps and a dedicated website interface. Users are supported for sending messages including exchanging photos, videos, stickers, audio, and files, and for interacting with bots, and voice and video calling.

### Other Embodiments Include

### Embodiment 101

A platform including all or any subset of:
multi-player game software, chat software; and a processor operative, for at least some of the time in which a game is in progress, to generate a display which presents a current state of the game in a first display area and also, simultaneously, a current state of an ongoing chat in a second display area and supports at least one of: chat by an end-user engaged in a game without exiting the game, participation in a game by an end-user engaged in a chat without exiting the chat, and moving from one game to another without exiting the chat.

### Embodiment 102

A platform according to any preceding embodiment wherein rules initiate and update the first display area by content written in the second aka messaging display area.

### Embodiment 103

A platform according to any preceding embodiment wherein said game includes a joke.

### Embodiment 104

A platform according to any preceding embodiment wherein said game includes a challenge.

### Embodiment 105

A platform according to any preceding embodiment wherein at least some dialogue or interaction between the user and the game software occurs via parsing, by the game software, of content that the user enters via the chat software.

### Embodiment 106

A platform according to any preceding embodiment wherein all dialogue or interaction between the user and the game software occurs only via parsing, by the game software, of content that the user enters via the chat software.

### Embodiment 107

A platform according to any preceding embodiment wherein the user can, while playing a game with other users U, chat with at least one end user who is not one of said other users U.

### Embodiment 108

A platform according to any preceding embodiment wherein the game software has at least one game archetype, and wherein plural games can be derived from said game archetype.

### Embodiment 109

Multi-player game software operative in conjunction with (existing or legacy) chat software, the game software including:

a processor operative to perform all or any subset of the following:
a. For at least some of the time in which a game is in progress, to generate a display which presents a current state of the game in a first display area, and also, simultaneously, a current state of an ongoing chat in a second display area and supports at least one of: chat by an end-user engaged in a game without exiting the game, participation in a game by an end-user engaged in chat without exiting the chat, and moving from one game to another without exiting the chat;
b. Rules initiate and update the first display area by content written in the second aka messaging display area.
c. At least some dialogue or interaction between the user and the game software occurs via parsing, by the game software, of content that the user enters via the chat software.
d. All dialogue or interaction between the user and the game software occurs only via parsing, by the game software, of content that the user enters via the chat software.
e. A user can, while playing a game with other users, U-chat with at least one end user who is not one of said other users U.
f. The game software has at least one game archetype, wherein plural games can be derived from said game archetype.

### Embodiment 1010

Processing circuitry comprising at least one processor and at least one memory and is configured to perform at least one of or any combination of the described operations, or to execute any combination of the described modules.

The term “chronologically ordered feed (or stream)” is intended to include a feed of chat messages or communications characterized in that it is true for most (e.g. 51% or 60% of 70% or 80% or 90% or 95% or even 100%) although perhaps not all pairs of communications within the feed (where each pair of communications includes an earlier communication generated earlier, and a subsequent communication generated later than said earlier communication), that the earlier communication appears in the feed before the subsequent communication. Typically, this is true for most, but perhaps not all pairs of chat communications, and/or for most, but perhaps not all pairs of game actions, and/or for most, but perhaps not all pairs of communications which include a chat communication (aka regular chat message) generated earlier, and a game communication e.g. game action generated subsequently, and/or for most, but perhaps not all pairs of communications which include a game communication e.g. game action generated earlier and a chat communication (aka regular chat message) generated subsequently.

The natural language characterization of the game action may include an indication of whether the game action e.g. guess was correct or incorrect, or an indication of how score/s of at least one chat participant, e.g. of the participant who generated the game action, is/are affected by the game action.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

### Embodiment 1

A computerized system which may be operative in conjunction with chat functionality which typically generates chats between chat participants aka chatroom members, wherein each or at least one chatroom member generates at least one chat communication typically within the chat, each chat participant typically being a cellphone user, each chat participant's cellphone typically having a display screen, the system including:
a game server including a hardware processor and typically operating at least one computerized game which, e.g. when started or joined by a chat participant, may allow the chat participant to generate at least one game action within the game; and/or
a client hardware processor e.g. cell app e.g. instant messaging app, that presents, to chat participants e.g. on their cellphones' display screens, a single chronologically ordered feed of communications which typically includes both chat communications and game actions.

### Embodiment 2

A system according to any of the preceding embodiments wherein the system also comprises the chat functionality.

### Embodiment 3

A system according to any of the preceding embodiments wherein the chat functionality is provided by a messaging server.

### Embodiment 4

A system according to any of the preceding embodiments wherein the at least one game action comprises an alphanumeric text.

### Embodiment 5

A system according to any of the preceding embodiments wherein a client side of the cell app sends the game action, comprising alphanumeric text, to
I. the messaging server, thereby to cause the messaging server to send the alphanumeric text as a chat message, to the chat participants; and
II. the game server.

### Embodiment 6

A system according to any of the preceding embodiments wherein the at least one game action is selected by a chat participant from among plural possible game actions presented by the game server.

### Embodiment 7

A system according to any of the preceding embodiments and wherein the client side sends the chat communication only to the messaging server and not to the game server.

### Embodiment 8

A system according to any of the preceding embodiments wherein the game response is sent by the game server to the client side and the client side sends the game response to the messaging server which sends the game response to the chat participants, as a chat message.

### Embodiment 9

A system according to any of the preceding embodiments wherein the game response, sent as a chat message, includes a gameboard, generated as a function of the game action and as a function of a gameboard which represented the game's state before the game action.

### Embodiment 10

A system according to any of the preceding embodiments wherein the game response, sent as a chat message, includes a natural language characterization of the game action, game server-generated by parsing the alphanumeric text.

### Embodiment 11

A system according to any of the preceding embodiments wherein the game response, sent as a chat message, includes an indication of a chat participant from among the chat participants, whose turn is now.

### Embodiment 12

A system according to any of the preceding embodiments wherein the game response and the game action which triggered the game server to generate the game response, are sent to the chat participants in the same chat message.

### Embodiment 13

A system according to any of the preceding embodiments wherein the chat communication comprises a chat message in natural language.

### Embodiment 14

A system according to any of the preceding embodiments wherein the messaging server comprises an XMPP server.

### Embodiment 15

A system according to any of the preceding embodiments wherein the chat functionality is provided by an external public messaging server.

### Embodiment 16

A system according to any of the preceding embodiments wherein a game action, when sent to the game server, triggers the game server to generate a game response.

### Embodiment 17

A system according to any of the preceding embodiments wherein the messaging server supports uploading, by end-users, of a victory gesture which is then presented to all members of a chatroom each time a given user wins a game in the chatroom.

### Embodiment 18

A computerized method operative in conjunction with chat functionality which generates chats between chat participants aka chatroom members, wherein each chatroom member generates at least one chat communication within the chat, each chat participant being a cellphone user, each chat participant's cellphone having a display screen, the method including:
providing a game server operating at least one computerized game which, when started or joined by a chat participant, allows the chat participant to generate at least one game action within the game; and
providing a client processor e.g. cell app e.g. instant messaging app, that presents, on chat participants' cellphones' display screens, a single chronologically ordered feed of communications including both chat communications and game actions.

### Embodiment 19

A computer program product, comprising a non-transitory tangible computer readable medium having computer readable program code embodied therein, the computer readable program code adapted to be executed to implement a method operative in conjunction with chat functionality which generates chats between chat participants aka chatroom members, wherein each chatroom member generates at least one chat communication within the chat, each chat participant being a cellphone user, each chat participant's cellphone having a display screen, the method including:
providing a game server operating at least one computerized game which, when started or joined by a chat participant, allows the chat participant to generate at least one game action within the game; and
providing a client processor e.g. cell app e.g. instant messaging app, that presents, on chat participants' cellphones' display screens, a single chronologically ordered feed of communications including both chat communications and game actions.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

It is appreciated that apps referred to herein may include a cell app, mobile app, computer app or any other Application software. Any Application may be bundled with a computer and its system software, or published separately. The term “phone” and similar used herein is not intended to be limiting, and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus the computing device may even be disconnected from e.g., WiFi, Bluetooth etc. but may be tethered directly or ultimately to a networked device.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “ui” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Example embodiments are illustrated in the various drawings. In the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

FIGS. 1a and 1b are simplified block diagrams of user interface components, all or any subset of which are included in the system, suitably interrelated e.g. as shown.

FIG. 2a illustrates a screenshot of an example display provided to end-users when a cell app is in on-game mode, including all or any subset of a game-board, chat-feed and keyboard.

FIG. 2b is a screenshot which may be provided to end-users, continuing the example of FIG. 2a, responsive to a player who sends a game action which includes a correct answer.

FIG. 2c is a screenshot which may be provided to end-users, continuing the example of FIGS. 2a-2b, showing a game response which includes a chat feed which typically is configured to present to game participants, the current gameboard and/or a natural language characterization of the most recent game action.

FIG. 3 is an example data structure; all or any subset of the shown elements may be provided.

FIGS. 4a-4b are example screenshots; all or any subset of the shown elements may be provided.

FIG. 5 is a semi-block diagram semi-pictorial illustration of an embodiment of the invention.

FIG. 6 is an example data structure for a game server engine; all or any subset of the illustrated components may be provided.

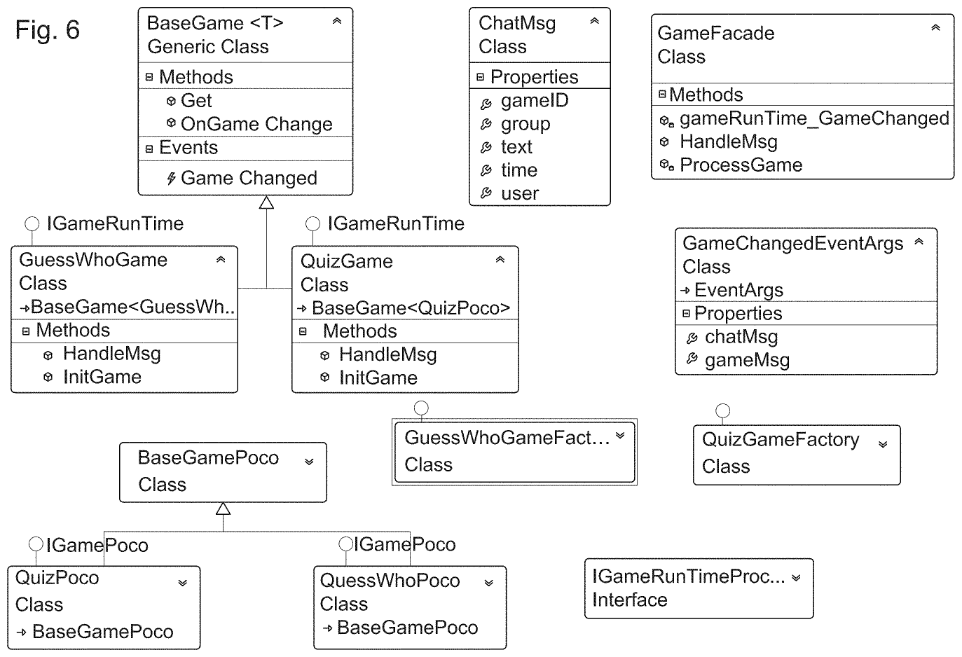

FIG. 7 is an example API Specification, all or any subset of whose methods and features may be provided, for communication between client and game server.

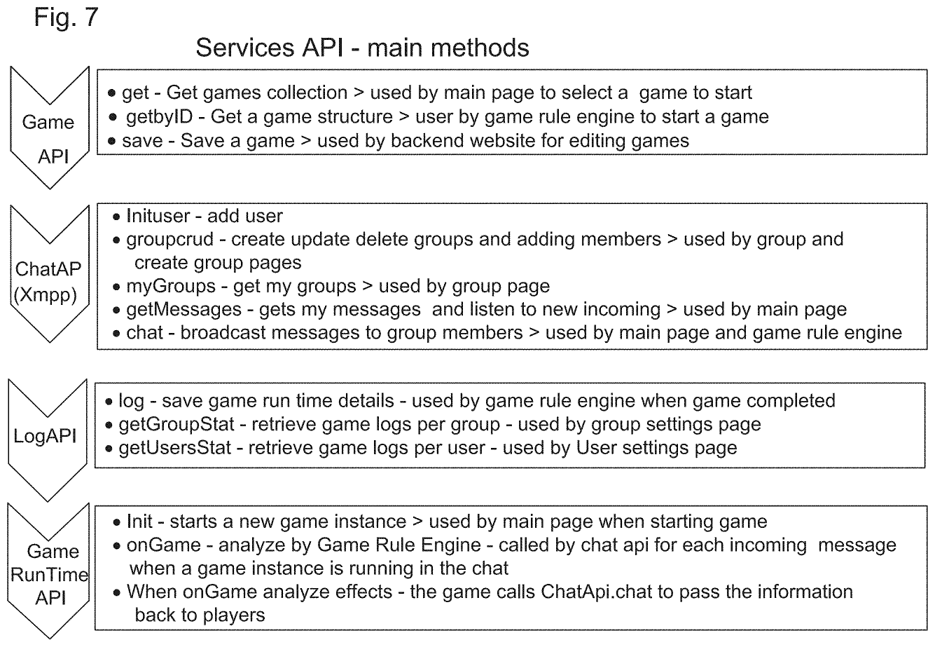

Computational, functional or logical components described and illustrated herein can be implemented in various forms, for example, as hardware circuits, such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

Certain embodiments seek to provide a system including an instant messaging app that combines games played as, or within, text on the chat, typically such that chat messages and game messages appear in chronologically order within the chat feed.

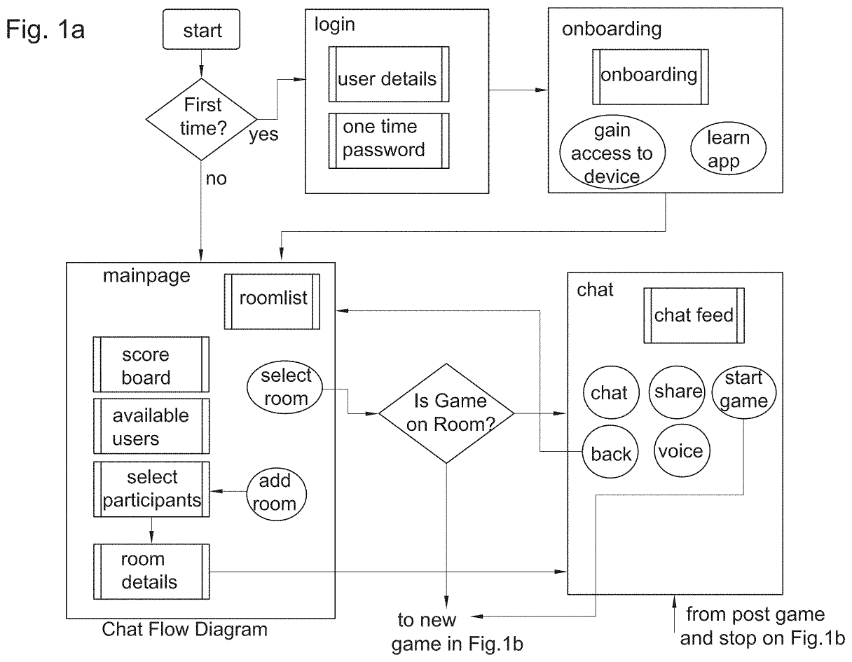

FIG. 1 is a simplified block diagram of user interface components, all or any subset of which are included in the system, suitably interrelated e.g. as shown. As shown, the UI components may include all or any subset of login functionality, onboarding functionality, main page functionality, chat page functionality, and a chat and play subsystem that may include all or any subset of the following: game init functionality, pre game (aka lounge) functionality, on game functionality, post game functionality.

In FIG. 1, each block may be autonomous. Passing between blocks may be only as indicated by arrows, according to certain embodiments. Passage between blocks interconnected by an arrow may occur automatically; as soon as the block at the root of the arrow has been finished, the system may automatically pass to the block at the head of the arrow. Thus for example, the system may pass automatically from pre-game or lounge stage, to on-game stage, to post-game stage.

The lounge stage may be configured according to any suitable logic. According to some embodiments, there is a timer and if a user starts a game in chatroom x, and no other users, or an insufficient number of users, join the game within M minutes (say 5 minutes), then the game closes, and the lounge stage terminates.

A reward scheme may be stored in memory so as to reward end users for starting games and/or for “being a leader” e.g. causing enough users to, e.g. before the lounge-stage times out, to join a game he has started (perhaps by calling them on the phone or by any other means), and/or for remaining in the chatroom for a predetermined waiting period e.g. until the lounge-stage times out. Thus, according to some embodiments, a user who starts a game gets a first reward, and/or a user who fails to attract enough other users, but does remain in the chatroom until timeout, may get a second reward, which may be larger than the first reward, and/or a user who attracts enough other users by timeout may get a third reward, which may be larger than the second reward, and/or a user who wins the game may get a fourth reward. Statistically, child users absent suitable configuration of lounge logic e.g. as described herein, tend to abandon the chatroom too quickly in the sense that other end-users may enter the chatroom to join Joy's game after Joy has already, prematurely, left the chatroom; thus Joy's premature exit may cause her game to be terminated un-necessarily, if the configuration of the chatroom had been such as to encourage Joy to stay, the game may not have been terminated.

It is appreciated that configuring the lounge stage to discourage premature end-user exits yields a system which has the effect of training end-users, particularly children, to tolerate delayed gratification.

The attention of the end user/s in the lounge stage may be engaged by any suitable stimuli such as visual or audio stimuli, prompting 2 users waiting for another end-user to play a quick 2-user game with one another, or prompting a single user to practice the game or play a solitary game; these lounge games may be abruptly terminated by the system in favor of the game in the chatroom, as soon as enough people join.

The lounge may also prompt the user to voice-call his friends (e.g. other participants of the same chatroom).

It is appreciated that configuring the lounge as described herein tends to encourage successful recruitment of enough players, within a reasonable time period, to allow games between chatroom participants, who actually know one another, to proceed, thereby to yield a true social experience, rather than resorting, as many conventional game software systems do, to allowing would-be game participants to play games with people s/he does not know.

At the end of the post-game stage, the system typically reverts to conventional chat mode and the end users see a conventional chatroom screen.

With regard to circles or ellipses, these may be implemented as input options e.g. virtual buttons; and an arrow exiting a circle or ellipse may indicate the block or state or stage that the system enters, if the input option represented by the circle or ellipse is selected by the user (if the virtual button is clicked upon by the user e.g.). For example, “start game” may lead the system to the “game init” block, and so forth.

In FIG. 1, blocks with double vertical lines e.g. “gameboard”, “victory”, etc. represent display elements which may be presented visually on end users' cellphone display screens. For example, “chatfeed” in FIG. 1 is typically a screen which displays all chat messages, typically including regular chat messages and game messages such as game actions and/or game responses, e.g. as described herein. In contrast, chat (represented as a circle) indicates a user option in which a user sends a regular chat message to others in the chatroom.

Thus the term chatfeed is intended to include a display screen which presents all chat messages to chat participants. The term chat refers to functionality which includes an end-user operation in which a chatroom participant sends a message, e.g. through a network such as the Internet, to other participants. Chat functionality may be implemented by any suitable processor, such as but not limited to a messaging server.

Generally, in FIG. 1, each rectangle typically is implemented as a display screen, and each circle or ellipse typically represents a user operation.

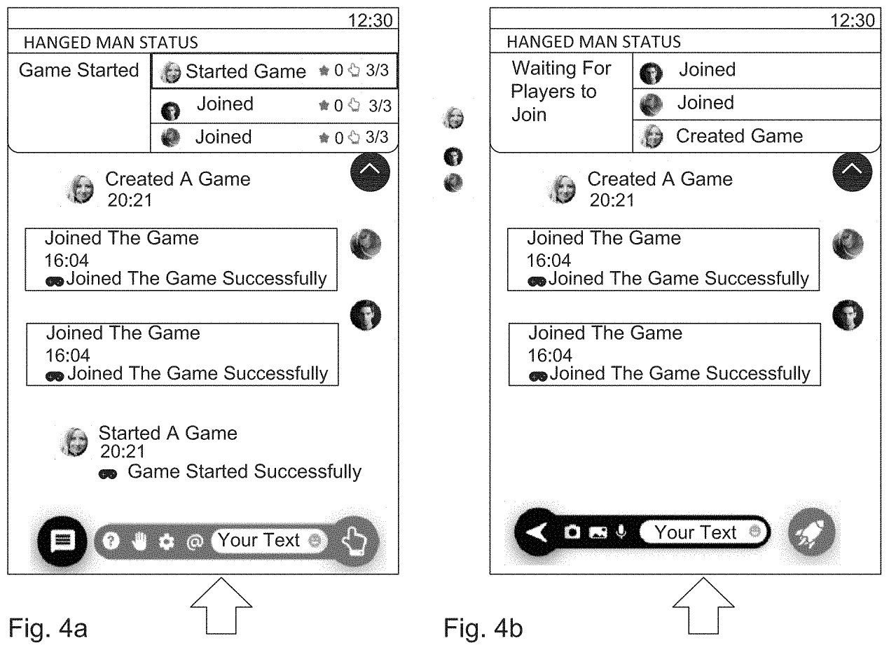

The following table aka “table 5” describes various elements in FIGS. 1a-1b; alternatively, elements may be as known in the art, for elements of the same or similar name in messaging apps, such as, say, Whatsapp.

| Component | SCREEN/Action | Remark | Main Sequence |
|---|---|---|---|
| Login | User Details | Input fields | Save Details and may |
| | | Nickname | send one time password |
| | | Phone number | as SMS to phone number |
| | | Picture | |
| | | Victory gesture | |
| Login | One time pass | Input fields | Compare Passwords If |
| | word | Password | correct |
| | | | Create a player on |
| | | | XMPP server |
| | | | Save JabId on local |
| | | | Navigate to Onboarding |
| Onboarding | Onboarding | Describe app | Navigate to main screen |
| | | Intro movie | |
| | | Force access to device to | |
| | | continue | |
| Onboarding | Gain access | Popup OS access | Navigate to main screen |
| | | permission | |
| Onboarding | Learn app | Load Tutorial | Navigate to main screen |
| Mainpage | Room list | Show messages grouped | Get from XMPP server |
| | | by rooms | and local storage current |
| | | | player messages |
| Mainpage | ScoreBoard | Show player and player | Get score on game server |
| | | friends scores | |
| Mainpage | Available Players | Show player friends that | Get available players |
| | | are now available for a | from game server |
| | | game or are in a game | |
| Mainpage | Select Room | From Room list player | Navigate to chat screen |
| | | clicked on a specific | |
| | | room | |
| Mainpage | Add Room | Create an new Chat | Display participants' |
| | | Room | control |
| Mainpage | Select | Choose the players that | Display Room Details |
| | participants | will be invited to the | control |
| | | room | |
| Mainpage | Room details | Input fields | Create a chatroom on |
| | | Room Name | XMPP server and/or |
| | | Room picture | Send notification to all |
| | | | room participants and/or |
| | | | navigate to chat screen |
| Chat | Chat feed | Show messages of the | Show archive messages |
| | | room | of the chosen room |
| | | | Sign player enters room |
| Chat | Chat | Add text to chat feed | Broadcast new message |
| Chat | Share | Open OS share dialog | Player who clicks the link |
| | | send link of the room | will automatically join |
| | | | the room |
| Chat | Voice | Start a voice chat | Open a VOIP channel |
| | | | between players in the |
| | | | room |
| Chat | Back | Leave room | Navigate to chat screen |
| Chat | Strat game | Player starts a new game | Navigate to game |
| | | | catalog screen |
| Game init | Game catalog | Show available | Load game catalog from |
| | | gameTypes that can be | game server. |
| | | started | After selection |
| | | | Start a new gameruntime |
| | | | in game server with |
| | | | selected game type. |
| | | | Navigate to game count |
| | | | down screen |
| Pre Game | game count down | Show pre game status | game server replay |
| | | How many players | gameruntime start with a |
| | | entered the room | message reply in the chat |
| | | How many times left | feed |
| | | until game disposes if | |
| | | game does not start | |
| Pre Game | Set game settings | Every GameType as | Display Available |
| | | specific settings a player | settings from game run |
| | | can edit for example in | time |
| | | the gametype 20 | In game server and save |
| | | questions where players, | settings after submit |
| | | by asking each other | |
| | | questions, should guess | |
| | | a content that is in | |
| | | another player’s mind | |
| | | setting will be how many | |
| | | questions allowed, what | |
| | | is the subject of the | |
| | | content (fruits, movie | |
| | | stars etc.) | |
| Pre Game | Chat feed | Same component as in | |
| | | chat | |
| Pre Game | Practice | Learn how to play the | Game runtime send a |
| | | gametype | practice note to the users |
| | | | and leads him, as in real |
| | | | game, to practice the |
| | | | game |
| Pre Game | Edit assets | Choose game asset and | Display and save assets |
| | | edit items of the game | in game server |
| | | for example in the game | |
| | | type ‘20 questions’ | |
| | | player can create his own | |
| | | category “nickname we | |
| | | call each other”, and add | |
| | | items in them. This asset | |
| | | will be available to game | |
| | | settings for rooms the | |
| | | player agrees | |
| Pre Game | voice | Same component as in | |
| | | Chat | |
| Pre Game | Chat | Same component as in | |
| | | Chat | |
| Prc Game | Add players | Same component as in | |
| | | MainPage - Select | |
| | | participants | |
| Prc Game | Start | Start a game with the | Game run time start |
| | | given game type and the | command is invoked. |
| | | players who entered the | Navigate to on game (e.g. |
| | | room | on game block in FIGS. 1a-1b) |
| Ongame | Gameboard | Top part of the screen | e.g. by chat binding |
| | | e.g. as per the | |
| | | embodiment of FIG. 4 | |
| Ongame | Chat feed | Same component as in | e.g. by chat binding |
| | | Chat | |
| Ongame | keyboard | Bottom part of the screen | e.g. by chat binding |
| | | e.g. as per the | |
| | | embodiment of FIG. 4 | |
| Ongame | Voice | Same component as in | |
| | | Chat | |
| Ongame | Poke | disturb other player | The disturb action will be |
| | | during game for example | invoked |
| | | player 1 | |
| | | requests players 2 screen | |
| | | will be out of focus for 5 | |
| | | seconds | |
| Ongame | Play | the actual game action a | e.g. as specified in detail |
| | | player elects or selects | in chat and play method |
| Ongame | STOP | quit the game | Gameruntime or game |
| | | | server is disposed; |
| | | | navigate to chat |
| | | | component |
| Ongame | Help | Show help tutorial of | Gameruntime or game |
| | | game type | server returns game help |
| | | | tutorial link to be |
| | | | displayed |
| Ongame | Game Ended | After play action finishes | Happens by gameruntime |
| | | for example in the game | or game server messages |
| | | ‘20 questions’, game | e.g. as described herein in |
| | | ends when player | terms of the gameruntime |
| | | guesses correctly the | or game server interface |
| | | content | |
| Post game | Victory | Show the game winner | Screen will have a count |
| | | gesture to all players | down 3 2 1 and then will |
| | | | take a picture of the |
| | | | winner player and |
| | | | broadcast it to all players |
| Post game | Score | Show all players' scores | game server may |
| | | after the game | compute wins and losses |
| | | | for each game and holds |
| | | | a score for each player as |
| | | | a result |
| Post game | Share | Open OS share to share a | Create a sum HTML data |
| | | link of specific game | of the game result which |
| | | results in the social | may include victory |
| | | media apps | gesture |

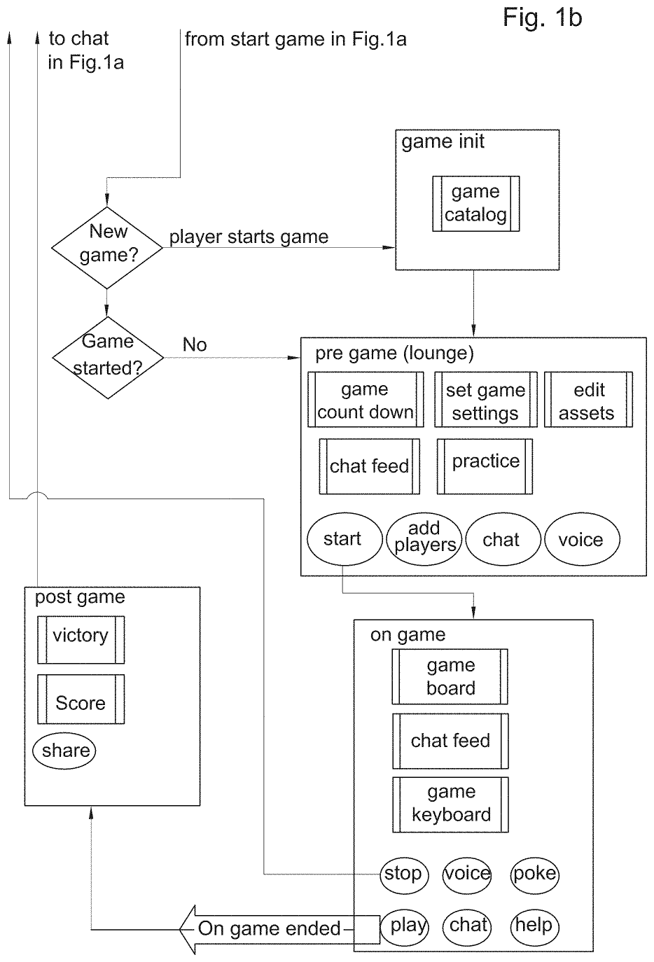

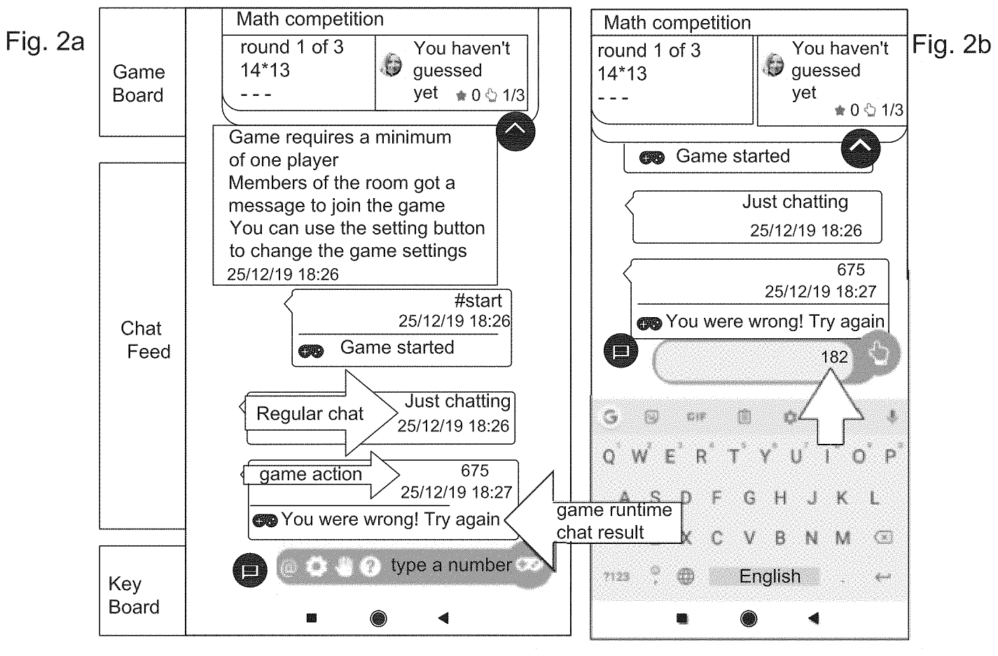

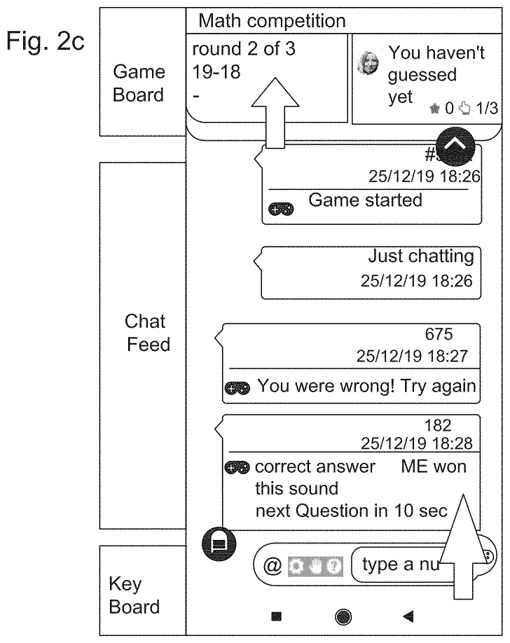

Chat binding is a term used herein for an operation occurring during ongame, in which each game response generated by the game server responsive to a game action updates the gameboard and the feed and the keyboard e.g. as described herein. Binding typically includes suitable presentation of suitable objects on screen, e.g. the screen of each user's cellphone, typically as chat messages. Thus a screen display or game response may include up to three areas or components (chat feed including feedback in natural language regarding game actions, keyboard, and gameboard, which may be the top area e.g. of the app screen e.g. as shown in FIG. 2a). All areas are typically updated responsive to the most recent game action.

The terms “game server” and “gameruntime” are used herein generally interchangeably. “gameruntime” may comprise an API.

It is appreciated that all mentions of “XMPP server” herein are intended more generally to include any other messaging server, and are not intended to be limiting.

A method, aka the “chat and play” method, typically runs when the system is in the on-game block or stage or state of FIG. 1. It is appreciated that the chat and play method herein is typically only activated when a game action is generated, and is not activated when a regular chat message is generated.

According to certain embodiments, a game begins when all or any subset of the following operations occur, in any suitable order e.g. as shown:
a. member m of chatroom c initiates a game e.g. by clicking on a virtual “start game” button
b. chatroom member m selects the game s/he wants to play
c. system enters pre-game state shown in FIG. 1
d. other members of chatroom c are notified e.g. via a chat message or SMS, of the proposed game in this particular chatroom. An invitation may be sent by the messaging server. The invitation typically indicates the identity of the chatroom member who initiated the game, and invites others to join the game.
e. any chatroom member who is present in the room may be considered a game participant. When the number of game participants has reached the minimal number of participants required for the selected game, system moves from pre-game to on-game state.

Alternatively, any other method may be used to allow a game to begin e.g. as triggered by a chatroom member.

According to certain embodiments, security is provided such that when a chatroom is generated, all participants are in the contact list of at least one other participant, whereas if end-user x is not on the contact list of any of a chatroom's participants, x will be barred by the system from joining this chatroom.

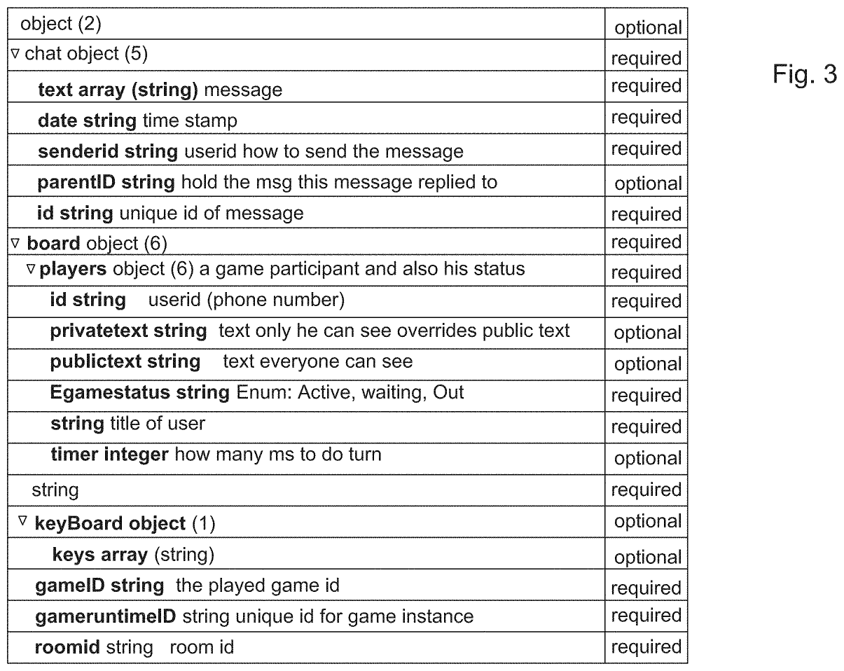

The following chat and play method may run e.g. while the system is on-game, and all or any subset of the following operations a-g, aka sequence, may occur, in any suitable order e.g. as shown:
a. a player, typically via the client side of the app, sends a game action to a messaging server e.g. an XMPP server (FIG. 2a), and from there to all players in the room as in regular chat. Alternatively or in addition, players may have joined a chatroom at any previous time e.g. similar to formation of groups in Whatsapp software.
b. the same game Action is also sent, typically simultaneously, to a game server (FIG. 2a) e.g. as a message
c. the game server processes the data received from the player (e.g. the message) e.g. by applying current init game logic which may be stored in the game catalog in the game init block of FIG. 1. An invitation may be sent by the messaging server. The invitation typically indicates the identity of the chatroom member who initiated the game and invites others to join the game. The game server may, accordingly, generate a game server response aka “game response” (which may comprise an “ongame” output returned by the gameruntime api). Typically, the game server, via a suitable API (aka gameruntime API) receives some of the messages (those which pertain to the game rather than pure chat messages, as described herein) and, responsively, sends game responses intended for the game participants.
d. the game server of FIG. 2a sends each game response to the XMPP server (or messaging server, since throughout this document, XMPP server is merely an example of possible messaging servers) of FIG. 2a. Each game response generated by the game server may include a current or new gameboard status. According to certain embodiments, the “game response” may be the same as the “action result” of FIG. 2a and/or the same as the object of FIG. 3. It is appreciated however that the data structure of FIG. 3 is but one possible data structure for a game response.
e. XMPP server of FIG. 2a receives the game server's response and responsively, sends the game response as a chat message (aka “game runtime chat result” in FIG. 2a) to all users. Typically, each game action generated by a player is processed by the gameruntime or game server, and its result is typically broadcast to all users in the chatroom.
f. the app typically attaches the game action to the game response. “attaching” refers to displaying a game action chat message and the corresponding game response as an additional chat message, on each chatroom member's phone screen, with no space between them, in contrast to other chat messages which are presented with some empty spaces between one message and the next.
   It is appreciated that the Chat module in FIG. 1 may append messages e.g. any of those described herein, to the Chat feed module in FIG. 1. Appending (aka “attaching”) may include adding another chat text in the chat feed. It is appreciated that modules and blocks herein may each include a hardware processor.

According to certain embodiments, attaching is performed at the client end. The client is operative to handle games via chat feed, e.g. as described herein. Specifically, the client logic of the application may be configured to attach a chat message b to a previous chat message a, each time the chat message b includes a parentID, or each time that chat message b includes a parentID which is identical to the parentID of chat message a.

It is appreciated that the embodiments of FIGS. 1, 2 and the data structure of FIG. 3 may be used to implement the client, but are not intended to be limiting.

Each game action generated by a user may be broadcast as-is to all participants, as a chat message.

Each game response is typically processed by the gameruntime or game server and may optionally be broadcast to all game participants as a single chat message including the game response together with (typically below) the game action which triggered the game response, or as above, as a separate chat message which may or may not be “attached” to the game action chat message.

The game action (e.g. participant p guesses the letter L in a hangman game) and the game response to that action (e.g. “L is not in the word! Q's turn now!”) may be sent to all game participants as two separate chat messages, or as a single chat message. g. the app replaces the previous gameboard status (say: the letters guessed before the current player's turn, in a Hangman game) with the current gameboard status (say, the letters guessed including a letter correctly guessed in the last player's turn).

FIG. 2A pictorially illustrates operation of a chat and play method provided according to certain embodiments, e.g. the above-described method. Typically, each game action reaches both a game server storing each game's logic, and an XMPP server which broadcasts the game action as a chat message as indicated by the “broadcast” arrow. The XMPP server also (as indicated by the “chatting arrow”) broadcasts “regular chat” including chat messages generated by players unrelated to the game which are typically not processed by, and do not reach, the game server. Responsive to each game action, the game server typically applies gameruntime or game server processes, which generate an action result from the game action. The action result typically goes from the game server to the XMP server, and is also broadcast to the players, as shown. Conventional chat messages may also, as is conventional, be broadcast to all players/chatroom members, typically at any time, including within the game.

According to certain embodiments, any text typed by the player (typically when the system is in chat state) is deemed to be a regular chat message, whereas if a player wants to generate a game response (typically when the system is in on-game state), s/he does this by selecting an option on the game's keyboard.

FIG. 2B is an example App screen for a chat and play method.

FIG. 2C is an example App screen: Answer affecting chat feed and gameboard by going to next round (a round or turn is defined by each game's logic and may be, say, a move made by one of two chessplayers, or a guess made by one of the players in a hangman, or each question in a quiz game which includes three questions).

A keyboard e.g. FIG. 4 chat and play keyboard may be used to represent possible game actions (not shown) that a game participant may select, such as various letters not yet guessed, in a hangman game, or such as four possible answers to a quiz question, in a quiz game. Thus according to certain embodiments, the keyboard, when in chat state, is a conventional operating system keyboard, whereas the keyboard in game state is game-specific and turn-specific, and displays only game actions possible within this game, and typically only game actions possible during this turn within this game (e.g., in hangman, not all 26 letters but instead only the subset of the 26 letters which have not yet been guessed).

### Gameboard

Any suitable system rules may be defined to determine which chatroom participants are defined as players of which game. For example, if a game in a chatroom starts after an end-user x has entered the chatroom, x may be automatically considered one of the game's players. Whoever is in the room when a game starts is considered a player.

If the game started before x entered, x may be allowed to view the game (each chatroom participant's game messages are sent to x as well) but is not considered a player.

A chatroom may as a default have no ongoing game in which case the chatroom operates as a conventional chatroom. If a chatroom participant has initiated or started a game, this is termed a chatroom which has a game “in action”.

The system rules may be that each chatroom has only one ongoing game, and no chatroom can have two games ongoing at the same time. However, a single player may be allowed to be a participant of plural chatrooms simultaneously.

While each game is ongoing, each game action is typically sent as a chat message to each of the game's players. Typically, the client software herein sends each game action both to the game server and, as a chat message, to all players of the game. Each game action typically comprises an alphanumeric text.

The system may allow a user to override certain defaults e.g. a user may opt to be only a viewer of a game that has started in “his” chatroom, and not a participant.

Typically, each game is preceded with a pregame or lounge stage e.g. as shown in FIG. 1, in which the game has not yet started e.g. since players may be in the process of joining the room or game. Typically, the lounge does not include any logic supporting play of the selected game with strangers, and/or does not include any logic supporting solitary play of the selected game.

Each game in the game catalog typically includes a stored indication of the minimal number of players that game requires. Until at least that number of players has joined, the game does not enter its on-game stage.

When a game starts, or when a player joins a room in which a game is already in action or when game server sends, e.g. via the messaging server, a message is sent to all chatroom participants who may, or may not be, a game response triggered by a game action generated by a user; the game server may also send a message not triggered by any game action e.g. “the 5 minutes allotted to finding an answer are up; so it's player 2's turn”.

The message sent by the game server to the users in the room may include all or any subset of the properties illustrated in FIG. 3. It is appreciated however that FIG. 3 is merely one possible example of a possible message structure. Typically, all gameruntimes or game servers support a single interface e.g. the generic data structure of FIG. 3.

For example, the message may include a chat object which may include all or any subset of the properties shown in FIG. 3, e.g. text, date string etc. as shown, or the message may include a gameboard object.

The message may include one or more players objects (e.g. one for each chatroom participant participating in the game) which may include all or any subset of the properties shown in FIG. 3 e.g. ID, private text string, public text string, etc.

According to certain embodiments, certain properties are defined as “required” and others as “optional”. An example of such a definition is shown in FIG. 3 (for example, the “object” property may be defined as optional, whereas the chat object may be defined as required, and the first to third and firth properties of the chat object may be defined as required, whereas the fourth property may be defined as optional, etc.). Alternatively, no such definition may be provided, or the required/option may be different than that illustrated, or all properties or objects may be optional.

The keyboard typically includes all options an end user is entitled to select when generating a game action. The keyboard is typically a display element inside a screen display generated by the game's logic or gameruntime or game server; thus “keyboard” typically does not refer to the virtual keypad generated by a user's cellphone for purposes of initiating telephone calls from that cellphone.

Typically, the system displays regular chat, game actions and game responses, all in one feed, e.g. as described herein, typically chronologically ordered e.g. as described herein. However, typically, each message which represents a regular chat message has a different appearance relative to chat messages representing game actions and/or game responses. For example, regular chat messages and game actions and/or responses may each appear in a different color (e.g. regular chat in black, game actions in red).

External actions pertaining to games may, even if not generated using the game keyboard because they are performed outside any game, e.g. starting the game or joining a game started earlier by another user, may be represented in red.

Performing an internal game action by suitable keyboard selection (e.g. triggering or activating an internal action within a game such as Help, Hint, quitting the game, Set game settings e.g. level of difficulty, language) may also be represented in the chat in red, if desired.

### Changing Modes:

Typically, when a user is in a chatroom s/he can alternate between chat mode, in which the user does not affect any game in session (in action e.g.) in the room, and game mode, in which the user is an active participant in the game. For example, the mobile device screen of the user may include two virtual buttons (e.g. as shown at the bottom of the screenshots of FIG. 4a) corresponding to the chat and game modes respectively. According to certain embodiments, the chat and play method herein is only activated by each of a user's actions if a user is in game mode and is not activated by the user's actions if the user is in chat mode. If game mode is selected, other virtual buttons may be displayed such as help, game level, etc. If chat mode is selected, conventional chat virtual buttons may be displayed such as chat, share files, etc.

It is appreciated that the “XMPP SERVER” referred to herein is but one example of a prevalent instant messaging technology; alternatively, any other messaging technology may be employed e.g. websocket. Thus all references to an XMPP server herein may alternatively refer to any messaging server.

Also, the messaging server may have any suitable graphic capabilities e.g. may allow each user to select or upload a victory gesture or image file or audio file which is then presented to all members of the chatroom each time this user wins a game. Or, users may select or upload an image or audio file which are presented to all members of a chatroom each time this user invites his friend to play a certain game with him. And/or, a different “invite” image or audio file may be stored for each game.

Conventional game servers are described here:
https://en.wikipedia.org/wiki/Game server.
The game server herein may resemble conventional game server, but is typically configured to send its game responses to the messaging server, rather than directly to players. Typically, the game server herein sends each action result to a messaging server, which may be a conventional off-the-shelf messaging server and need not be specially designed. According to certain embodiments, the messaging server may be an external and/or public and/or legacy and/or existing server rather than being dedicated solely to or operative solely in conjunction with or customized specifically for the functionalities or cell app specifically shown and described herein.

The games in the game catalog associated with the game server, are typically text games in which each game action comprises an alphanumeric string aka text. Each game's logic is typically stored in memory, accessible to the game server.

Each game typically is configured to be compatible with the game server.

Each game may generate game responses e.g. as per the data structure of FIG. 3 herein.

Each game's logic typically ensures that the game ends within a finite period of time.

Example game types:
Quiz—which of the quiz participants generates a correct answer to a quiz question fastest, in games such as 20 questions, Prisoner's dilemma, Hangman.

Games may also include pragmatic, rather than necessarily entertaining, interactions between chatroom participants, such as setting up an appointment. For example, an appointment “game” may begin with a first turn in which a player suggests an appointment e.g. “basketball this Tuesday at 3 pm, who's coming?” either in natural language or by filling in a form such as “ACTIVITY will take place DATE TIME at LOCATION, who's coming?”. Then the input options may be “coming” “can't come” and “may be”, and the gameboard states may be a simple indication of the number and/or identity of people who are and/or are not coming.

Each game time may has a different gameruntime that holds the logic of the game.

In a quiz game, each game action may include an answer to a quiz question.

If the game is Hangman, each game action may include a letter from a-z which the player thinks is in the unknown word.

In general, it is appreciated that game actions may comprise selection from a typically finite set of game actions associated in memory with each game, or may comprise a natural language response, in which case parsing of the response may be performed by natural language processing logic associated in memory with each game, typically including parsing chat messages generated by chatroom participants as either being a natural language game response, or being a regular chat message. For example, the natural language processing logic associated with the appointment “game” above may categorize or classify each chat message generated during the game as either “coming”, “may be”, “not coming” or a regular (“other”) chat message not intended to be a game action. Or, the natural language processing logic associated with a Hangman game may categorize or classify each chat message generated during the game as belonging to one of 27 categories: either one of the 26 letters of the alphabet, or “other”, where the last, 27^{th} category includes all regular chat messages that were not intended to be a guess of any of the letters of the alphabet, such as “is there a math test tomorrow? Did you guys study for it?”, or “you're such an IDIOT!”

Alternatively, parsing of natural language responses may be simplified by requiring users to indicate (e.g. by pressing one of two buttons) whether his chat message is a game action or a regular chat message, in which case there is no “other” category.

It is appreciated that as described herein, chat messages which are game actions are typically sent to both the messenger (aka “messaging”) and game servers, whereas regular chat messages are typically sent only to the messenger (aka “messaging”) server.

Each game typically has its own repertoire of game responses. For example, in Hangman, each correctly guessed letter sent in a game action may result in a game response of sending “correct” feedback and/or leaving the turn with the player who made the correct guess and/or a new gameboard in which the just-guessed letter now appears in the word. In contrast, each incorrectly guessed letter sent in a game action may result in a game response of sending “incorrect” feedback and/or passing the turn on to the player next to the one who made the incorrect guess.

Typically, each game continues until the game server announces that the game is over, at which point the system herein typically enters the “post-game” block (aka stage) in FIG. 1. For example, “game over” may occur when one of the players has accumulated 100 points, or when the maximum number of allowed guesses has been exhausted, or when any other game-over criterion has become true.

It is appreciated that during a game, a player may generate both game actions (such as his answer to a quiz question) and chat messages such as “wow, this question is hard”.

Typically, each game action generated by player x is sent e.g. as a chat message to all game players, with an indication that this game action was generated by player x. Any response to a game action may be sent to all game players as well, typically associated with the game action which triggered the response.

As shown in FIG. 1, each game is typically associated with a gameboard and/or with a keyboard. The keyboard displays to each player all options available to him, when generating a game action. For example, a Hangman keyboard may show all letters of the alphabet, or may show only those letters of the alphabet that have not yet been guessed by game participants. A multiple choice quiz keyboard may display plural possible answers to each quiz question e.g. Paris, Bonn, Washington, and Jerusalem, responsive to a question asking “what is the capital of Israel?”

The keyboard also typically includes options other than possible game actions e.g. all or any subset of help, quit game, open a voice channel between game participants, etc., also as shown (in circles/ellipses) in FIG. 1.

The gameboard displays the state of the game e.g. a word with some letters already filled in because they have already been correctly guessed by game participants, and other letters still blank because they remain to be guessed, in Hangman.

Example: in the game known as “7 boom”, players count in turn from 1 to, say 1000. However, each player must not say any number that divides by, or includes 7. The gameboard will display the number just generated by the previous participant in her or his game action (or the number corresponding to the “boom” generated by the previous participant), such as 349 or 369 or 3. The keyboard may, in this game, include two options at each turn: the number following the number on the gameboard, and “boom”. Thus if the gameboard shows 349, the next participant's keyboard will show 350 and boom, and if the next participant selects boom, the feedback included in the game response may be “correct”! if the gameboard shows 369, the next participant's keyboard will show 370 and boom and if the next participant selects boom the feedback included in the game response may be “correct”! if the gameboard shows 3, the next participant's keyboard will show 4 and boom and if the next participant selects boom the feedback included in the game response may be “incorrect!”.

For some games, a single display may serve both as gameboard and as keyboard. For example, in tic-tac-toe, nine squares may be displayed, both to present the state of the game (which of the nine squares already contain and x or an “o”) and to present user options, namely the blank squares.

For some games, the gameboard may be a video sequence, displayed to all users, and game actions may comprise respective branchings of the video sequence. For example, a chat participant may be presented with three options, “attack dragon”, “attack shark” or “don't attack” and the video sequence then branches respectively into a sequence in which an icon corresponding to the chat participant attacks a dragon appearing in the video, a sequence in which the icon corresponding to the chat participant attacks a shark appearing in the video, or a sequence in which neither of the above occur.

It is appreciated that more generally, any function or logic which accepts texts or other user inputs, typically but not necessarily from among a set of possible user inputs presented to the user, and responds to them, may be a game. Typically each game includes an end-criterion determining when the game ends (e.g. “when the first player reaches 100 points”, “when only one player is left in the game”, “after 5 minutes from start-time of game”, etc.) and a win-criterion or score-criterion indicating which player has won or has accumulated points. A game may include a random number generator e.g. to determine which quiz question should be presented next, from among a large pool of quiz questions stored in memory, each associated with a number.

It is appreciated that each table herein may be modified by changing or omitting any row, column or cell e.g. as per the prior art of the teachings herein.

The game catalog, which typically resides in the memory of the game server, stores init game logic, generated in advance for each of plural games.

It is appreciated that code that gets a text and returns a text as per a certain logic, may function as a game in the platform herein and the logic is termed herein the “game logic”.

When generating a game, in conventional game servers the client side performs an action and the game server is configured to apply game logic and return the resulting feedback to the client side. In contrast, the game server herein is typically configured to return the feedback via the messaging communication functionality, e.g. XMPP, e.g. as a chat message, to all chatroom participants. A suitable data structure is provided such as the data structure of FIG. 3, which is broadcast to all chatroom members.

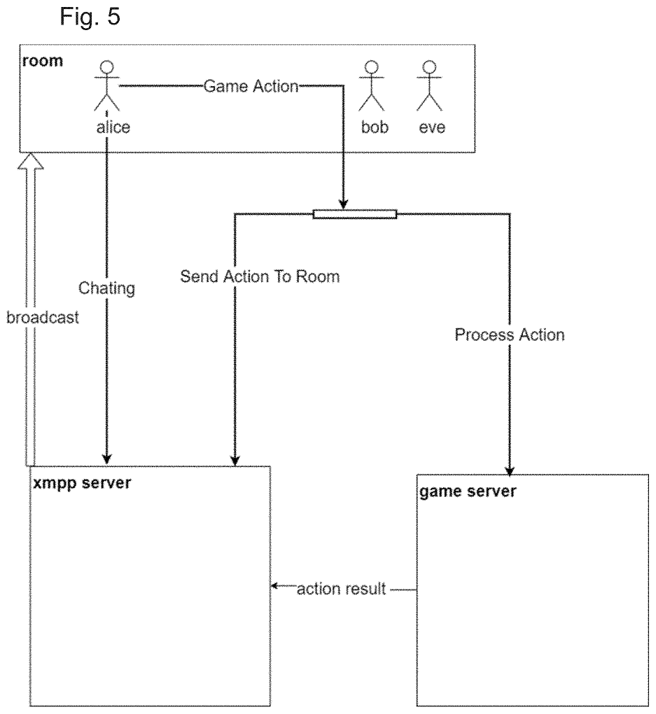

Following is an example of a (portion of a) main stream data flow or sequence of game action arrows, e.g. see FIG. 5. All or any subset of the following operations may be performed, in any suitable order e.g. as shown:
i. Client app passes to the server the room, player and a string that represents the game action.
ii. Game server gets an object that holds a game state by room (e.g. a game state associated with a specific room).
ii. Game server passes the object to game logic code. The resulting data may for example have the format described in FIG. 4 and may change the state of the game. For example, if the game is Hangman, the current state of the game may be that the game has three players, Alice, Bob and Eve, the target word to guess is “example”, the already-correctly-guessed letters are e x a_ _ _e, and it is Alice's turn to guess. If Alice guesses the letter n, the game logic checks if n is in the target word and finds n is not in the target word hence returns a response in the chat object that “n” is not in the word and that the turn is now Bob's, as well as a change in the state of the game object e.g. to indicate that it is now Bob's turn. If Alice guesses the letter m, the game server adds “m” to the visible (already correctly guessed) letters (which are now exam e) and writes in the chat object natural language feedback such as “correct!! It's your turn again try another letter!” and indicates that the turn is still Alice's. In both of the above cases, the result object of the game logic is typically transformed to the XMPP and typically for all online room players, and is typically bound to screen e.g. as described in FIGS. 2a-2c.

It is appreciated that, whenever possible, the term “chat message” has been used herein to refer to messages generated by the messaging server which may include a chat communication (natural language communication generated conventionally by a chatroom member which is typically not parsed by the game server), or may include a game communication (either a game action, typically selected by a game participant from various keyboard selections, or a game response of the game server to a game participant's game action.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a network e.g. web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

A system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node.

It is appreciated that any features, properties, logic, modules, blocks, operations or functionalities described herein which are, for clarity, described in the context of separate embodiments, may also be provided in combination in a single embodiment except where the specification or general knowledge specifically indicates that certain teachings are mutually contradictory and cannot be combined. any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

Each element e.g. operation described herein may have all characteristics and attributes described or illustrated herein or according to other embodiments, may have any subset of the characteristics or attributes described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, Radio communication, HomePNA, power line communication, cell phone, VR application, Smart Phone (e.g. iPhone), Tablet, Laptop, PDA, Blackberry GPRS, Satellite including GPS, or other mobile delivery.

It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example and instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include apparatus, whether hardware, firmware or software, which is configured to perform, enable or facilitate that operation or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

1. A computerized system operative in conjunction with chat functionality which generates chats between chat participants aka chatroom members, wherein each chatroom member generates at least one chat communication within the chat, each chat participant being a cellphone user, each chat participant's cellphone having a display screen, the system including:
a game server including a hardware processor and operating at least one computerized game which, when started or joined by a chat participant, allows the chat participant to generate at least one game action within the game; and
a client hardware processor that presents, on chat participants' cellphones' display screens, a single chronologically ordered feed of communications including both chat communications and game actions.

2. A system according to claim 1 wherein the system also comprises said chat functionality.

3. A system according to claim 1 wherein said chat functionality is provided by a messaging server.

4. A system according to claim 1 wherein said at least one game action comprises an alphanumeric text.

5. A system according to claim 1 wherein a. client side of said cell app sends said game action, comprising alphanumeric text, to
I. the messaging server, thereby to cause the messaging server to send the alphanumeric text as a chat message, to said chat participants; and
II. the game server.

6. A system according to claim 1 wherein said at least one game action is selected by a chat participant from among plural possible game actions presented by said game server.

7. A system according to claim 5 and wherein the client side sends said chat communication only to said messaging server and not to said game server.

8. A system according to claim 7 wherein the game response is sent by said game server to said client side and said client side sends said game response to the messaging server which sends said game response to the chat participants, as a chat message.

9. A system according to claim 8 wherein the game response, sent as a chat message, includes a gameboard, generated as a function of said game action and as a function of a gameboard which represented the game's state before the game action.

10. A system according to claim 8 wherein the game response, sent as a chat message, includes a natural language characterization of the game action, game server-generated by parsing said alphanumeric text.

11. A system according to claim 8 wherein the game response, sent as a chat message, includes an indication of a chat participant from among the chat participants, whose turn is now.

12. A system according to claim 8 wherein the game response and the game action which triggered the game server to generate the game response, are sent to the chat participants in the same chat message.

13. A system according to claim 1 wherein said chat communication comprises a chat message in natural language.

14. A system according to claim 3 wherein said messaging server comprises an XMPP server.

15. A system according to claim 3 wherein said chat functionality is provided by an external public messaging server.

16. A system according to claim 1 wherein a game action, when sent to the game server, triggers the game server to generate a game response.

17. A system according to claim 3 wherein the messaging server supports uploading, by end-users, of a victory gesture which is then presented to all members of a chatroom each time a given user wins a game in the chatroom.

18. A computerized method operative in conjunction with chat functionality which generates chats between chat participants aka chatroom members, wherein each chatroom member generates at least one chat communication within the chat, each chat participant being a cellphone user, each chat participant's cellphone having a display screen, the method including:
providing a game server operating at least one computerized game which, when started or joined by a chat participant, allows the chat participant to generate at least one game action within the game; and
providing a client processor e.g. cell app e.g. instant messaging app, that presents, on chat participants' cellphones' display screens, a single chronologically ordered feed of communications including both chat communications and game actions.

19. A computer program product, comprising a non-transitory tangible computer readable medium having computer readable program code embodied therein, said computer readable program code adapted to be executed to implement a method operative in conjunction with chat functionality which generates chats between chat participants aka chatroom members, wherein each chatroom member generates at least one chat communication within the chat, each chat participant being a cellphone user, each chat participant's cellphone having a display screen, the method including:
providing a game server operating at least one computerized game which, when started or joined by a chat participant, allows the chat participant to generate at least one game action within the game; and
providing a client processor e.g. cell app e.g. instant messaging app, that presents, on chat participants' cellphones' display screens, a single chronologically ordered feed of communications including both chat communications and game actions.
